(19) United States
(12) Patent Application Publication
(10) Pub. No.: US 2007/0192520 A1
(43) Pub. Date: Aug. 16, 2007

(54) SYSTEM CONTROL UNIT, SYSTEM CONTROL METHOD, AND COMPUTER READABLE MEDIUM STORING SYSTEM CONTROL PROGRAM

(75) Inventor: TAKAYUKI ITO, Yamanashi (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/670,532

(22) Filed: Feb. 2, 2007

(30) Foreign Application Priority Data
Feb. 10, 2006 (JP) 2006-34402

(51) Int. Cl. G06F 13/38

(52) U.S. Cl. 710/62

(57) ABSTRACT

A system control unit includes a first IO (Input/Output) node having a primary BIO (Basic Input/Output) preferentially used, and a second IO node having a secondary BIO used as a preparatory of the primary BIO. A first address space allocated to the first IO node, and a second address space allocated to the second IO node are different from each other. The system control unit performs an information changing process that accesses the first IO node in the first address space to change information in the primary BIO, and accesses the second IO node in the second address space to change information in the secondary BIO, thus bringing the information in the primary BIO and the information in the secondary BIO into agreement.

### BACKGROUND OF THE INVENTION

1. Field of the Invention

The present invention relates to a system control unit, a system control method, and a computer readable medium storing a system control program that enable a system to be normally started up in the event of system failure due to a fault in an IO (Input/Output) node having a BIO (Basic Input/Output) in a large-scale computer system.

2. Description of the Related Art

In a conventional large-scale computer system, when mounted with plural CPU nodes and an IO node not having BIO, even when the system fails due to a fault in the CPU nodes or the IO node, and the CPU nodes and the IO node are separated, it has been possible to start up the system again. However, when the system is mounted with an IO node having BIO, in the case where the IO node is separated, it has been impossible to start up the system again.

This is because the BIO includes functions required for the system such as RTC (Real Time Clock), a nonvolatile memory, and system timer, and it is impossible to start up the system without the BIO.

To avoid the above-described problem, one idea is to mount a preparatory BIO in the system aside from an IO node having an original BIO preferentially used, and start up the system again using the preparatory BIO when the IO node having the original BIO preferentially used fails and is separated.

However, the BIO has two functions that must retain operation-time values before use.

A first function is an RTC to hold date and time information. When the system is started up again using the preparatory BIO, if the value of the RTC deviates greatly from an original value (the value of the RTC of the original BIO), during system startup, date and time information of the OS (Operating System) and the like will deviate greatly from the original date and time.

What is particularly problematic is that date and time information is returned earlier than operation time before use. The occurrence of this problem would make log information recorded by the OS and various applications incorrect and disable rollback control of databases, thereby exerting a bad influence on the operation of the OS and the applications.

A second function is a nonvolatile memory for storing startup information to be held across system startup by the OS, BIOS (Basic Input/Output System), and the like. When the system is started up again using the preparatory BIO, if the value of the nonvolatile memory changes from an original value (the value of the nonvolatile memory of the original BIO), the setting of the BIOS would change from an original setting point, or the boot path of the OS would change from an original one, so that the system may not be normally operated.

Specifically, to normally start up the system by using the preparatory BIO, information of the RTC and the nonvolatile memory in the original BIO must match information of the RTC and the nonvolatile memory in the preparatory BIO. A possible method is to change information of the RTC and the nonvolatile memory in the preparatory BIO when information of the RTC and the nonvolatile memory in the original BIO is changed.

Fortunately, in the requirements of DIG64 (specification concerning compatibility of hardware/software in the IA-64 platform, and http://www.dig64.org/home), the OS and applications are not permitted to directly access the RTC and the nonvolatile memory; functions provided by the BIOS must always be used for the access. Therefore, without having to modify general OSs and applications, the SW (Soft Ware) side has only to modify only the BIOS.

However, functions such as RTC, nonvolatile memory, and system timer have maintained compatibility since the age of AT compatibles (PC (Personal Computer) put on the market by IBM Corporation in 1984 and PC based on AT (Advanced Technology)), and it is presupposed that any of them is unique within a system. Therefore, address spaces used by BIO controllers used in large quantities in general PCs and the like (e.g., ICH4 of Intel Co.) are fixed to address allocation of AT compatibles, and cannot be changed under present circumstances.

Therefore, address spaces overlap between an original BIO and a preparatory BIO and the system cannot be started up, with the result that information of an RTC and a nonvolatile memory in the original BIO, and information of an RTC and a nonvolatile memory in the preparatory BIO cannot be brought into agreement.

As a technical document disclosed before the present invention, there is an address allocation apparatus that efficiently allocates I/O address spaces in a large-scale computer system (see JP-A No. 2003-337788). The address allocation apparatus includes a base address register setting means that allocates respective PCI devices to respective subdivided I/O address spaces produced by subdividing an I/O address space, allocates the I/O address spaces of respective secondary PCI buses to the subdivided I/O address spaces in a cross multiplication manner, and sets a base address register, and a routing register setting means that allocates I/O address spaces allocated to the respective secondary PCI buses to the I/O address spaces of respective first PCI buses in a cross multiplication manner.

The above-described JP-A No. 2003-337788, which intends to efficiently allocate I/O address spaces in a large-scale computer system, does not consider normal startup of a system when a fault occurs in an IO node having a BIO.

### SUMMARY OF THE INVENTION

The present invention has been made in view of the above circumstances and provides a system control unit, a system control method, and a computer readable medium storing a system control program that enable a system to be normally started up when a fault occurs in an IO node having a BIO (Basic Input/Output).

To achieve this object, the present invention has characteristics described below.

A system control unit according to an embodiment of the present invention includes a first IO (Input/Output) node having a primary BIO (Basic Input/Output) preferentially used, and a second IO node having a secondary BIO used as a preparatory of the primary BIO; a first address space allocated to the first IO node, and a second address space allocated to the second IO node are different from each other; and the system control unit includes an information changing means that accesses the first IO node in the first address space to change information in the primary BIO, and accesses the second IO node in the second address space to change information in the secondary BIO, thus bringing the information in the primary BIO and the information in the secondary BIO into agreement.

In the system control unit according to an embodiment of the present invention, the secondary BIO has a specific address space, and the second IO node includes an address conversion means that, on receiving an I/O transaction to the second address space, converts the address of the received I/O transaction to indicate the specific address space, and issues the address of the converted I/O transaction to the secondary BIO to change information in the secondary BIO.

In the system control unit according to an embodiment of the present invention, the primary BIO has a specific address space, and the first IO node includes an address conversion means that, on receiving an I/O transaction to the first address space, converts the address of the received I/O transaction to indicate the specific address space, and issues the address of the converted I/O transaction to the primary BIO to change information in the primary BIO.

In the system control unit according to an embodiment of the present invention, the information changing means is executed at least one of during system startup, and during a change request from the OS.

In the system control unit according to an embodiment of the present invention, the primary BIO and the secondary BIO include a date and time information holding means that holds date and time information, and a startup information holding means that holds startup information required during startup of the system, and the information changing means brings date and time information and startup information in the primary BIO, and date and time information and startup information in the secondary BIO into agreement.

A system control method according to an embodiment of the present invention is performed in a system control unit including a first IO (Input/Output) node having a primary BIO (Basic Input/Output) preferentially used, and a second IO node having a secondary BIO used as a preparatory of the primary BIO; a first address space allocated to the first IO node, and a second address space allocated to the second IO node are different from each other; the system control unit performs an information changing process that accesses the first IO node in the first address space to change information in the primary BIO, and accesses the second IO node in the second address space to change information in the secondary BIO; and the information in the primary BIO and the information in the secondary BIO are brought into agreement.

In the system control method according to an embodiment of the present invention, the secondary BIO has a specific address space, and the second IO node, on receiving an I/O transaction to the second address space, converts the address of the received I/O transaction to indicate the specific address space, and issues the address of the converted I/O transaction to the secondary BIO to change information in the secondary BIO.

In the system control method according to an embodiment of the present invention, the primary BIO has a specific address space, and the first IO node, on receiving an I/O transaction to the first address space, converts the address of the received I/O transaction to indicate the specific address space, and issues the address of the converted I/O transaction to the primary BIO to change information in the primary BIO.

In the system control method according to an embodiment of the present invention, the information changing process is executed at least one of during system startup, and during a change request from the OS.

In the system control method according to an embodiment of the present invention, the primary BIO and the secondary BIO include a date and time information holding means that holds date and time information, and a startup information holding means that holds startup information required during startup of the system, and the information changing process brings date and time information and startup information in the primary BIO, and date and time information and startup information in the secondary BIO into agreement.

A computer readable medium storing a system control program according to an embodiment of the present invention is executed in a system control unit includes a first IO (Input/Output) node having a primary BIO (Basic Input/Output) preferentially used, and a second IO node having a secondary BIO used as a preparatory of the primary BIO; a first address space allocated to the first IO node, and a second address space allocated to the second IO node are different from each other; the system control program instructs the system control unit to perform information changing processing that accesses the first IO node in the first address space to change information in the primary BIO, and accesses the second IO node in the second address space to change information in the secondary BIO; and the information in the primary BIO and the information in the secondary BIO are brought into agreement.

In the computer readable medium storing the system control program according to an embodiment of the present invention, the secondary BIO has a specific address space, and the second IO node, on receiving an I/O transaction to the second address space, converts the address of the received I/O transaction to indicate the specific address space, and issues the address of the converted I/O transaction to the secondary BIO to change information in the secondary BIO.

In the computer readable medium storing the system control program according to an embodiment of the present invention, the primary BIO has a specific address space, and the first IO node, on receiving an I/O transaction to the first address space, converts the address of the received I/O transaction to indicate the specific address space, and issues the address of the converted I/O transaction to the primary BIO to change information in the primary BIO.

In the computer readable medium storing the system control program according to an embodiment of the present invention, the information changing processing is performed at least one of during system startup, and during a change request from the OS.

In the computer readable medium storing the system control program according to an embodiment of the present invention, the primary BIO and the secondary BIO include a date and time information holding means that holds date and time information, and a startup information holding means that holds startup information required during startup of the system, and the information changing processing brings date and time information and startup information in the primary BIO, and date and time information and startup information in the secondary BIO into agreement.

According to an embodiment of the present invention, in a system control unit including a first IO (Input/Output) node having a primary BIO (Basic Input/Output) preferentially used, and a second IO node having a secondary BIO used as a preparatory of the primary BIO, a first address space allocated to the first IO node, and a second address space allocated to the second IO node are different from each other, access is made to the first IO node in the first address space to change information in the primary BIO, and access is made to the second IO node in the second address space to change information in the secondary BIO so that the information in the primary BIO and the information in the secondary BIO are brought into agreement, whereby the system can be normally started up when a fault occurs in the first IO node having the primary BIO preferentially used.

### BRIEF DESCRIPTION OF THE DRAWINGS

FIG. 1 is a drawing showing a system configuration of a large-scale computer system in this embodiment; and

FIG. 2 is a drawing showing an I/O address map in a large-scale computer system in this embodiment.

### DETAILED DESCRIPTION OF THE PREFERRED EMBODIMENTS

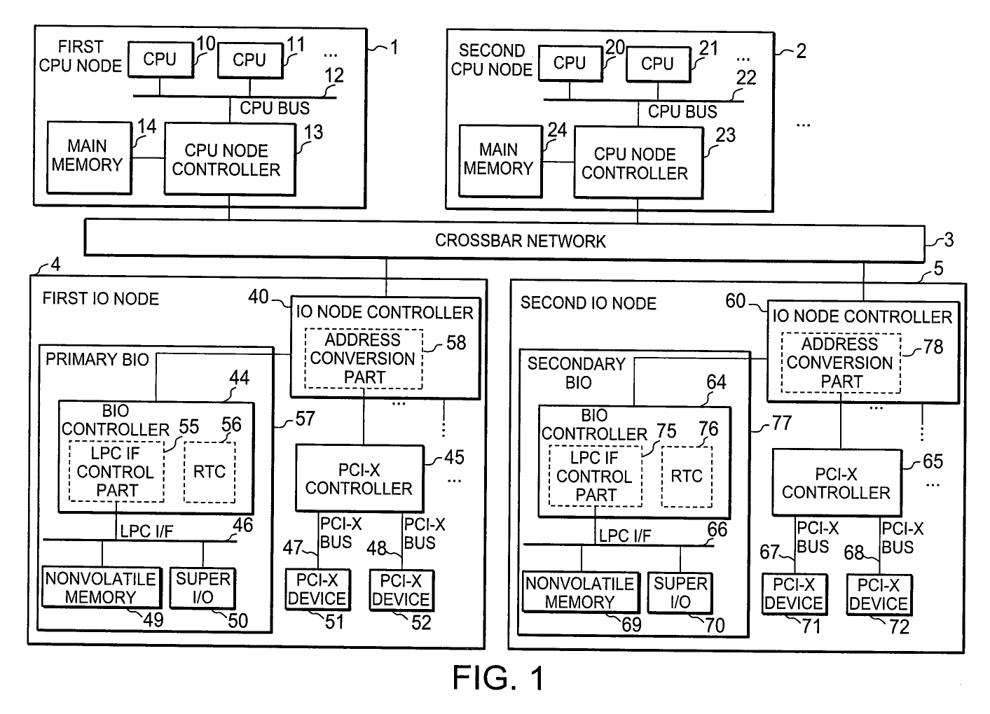

With reference to FIG. 1, features of a system control unit in this embodiment will be described. The system control unit in this embodiment includes a first IO (Input/Output) node (4) having a primary BIO (Basic Input/Output) (57) preferentially used, and a second IO node (5) having a second BIO (77) used as a preparatory of the primary BIO (57). A first address space allocated to the first IO node (4) and a second address space allocated to the second IO node (5) are formed in different address spaces. The system control unit accesses the first IO node (4) in the first address space to change information in the primary BIO (57), and at the same time accesses the second IO node (5) in the second address space to change information in the second BIO (77), thereby bringing the information in the primary BIO (57) and the information in the second BIO (77) into agreement.

Specifically, as shown in FIG. 1, the second IO node (5) allocates 1 K bytes of I/O address space of an I/O address space allocated to the second IO node (5) by BIOS to a secondary BIO (77), and sets a least significant address of the allocated I/O address space in an address conversion base register in an address conversion part (78) in the second IO node (5).

On receiving an I/O transaction to the I/O address space allocated to the second IO node (5) from the BIOS, the second I/O node (5) converts the I/O transaction into an I/O transaction of an I/O address space obtained by subtracting the least significant address set in the address conversion base register in the address conversion part (78) from the I/O address space of the received I/O transaction, and issues the I/O transaction of the converted I/O address space to the secondary BIO (77) to change information of RTC (76) and a nonvolatile memory (69) in the second BIO (77).

By doing so, the BIOS, which operates on the CPU nodes (1, 2) and provides basic functions for the OS and the like, can perform control so as to change not only information of an RTC (56) and a nonvolatile memory (49) in the primary BIO (57) accessible in a specific I/O address space allocated in a general system, but also information of an RTC (76) and a nonvolatile memory (69) in the secondary BIO (77) accessible in an I/O address space set in the address conversion base register in the address conversion part (78). During system startup, it also copies information of the RTC (56) and the nonvolatile memory (49) in the primary BIO (57) into the RTC (76) and the nonvolatile memory (69) in the secondary BIO (77) so that information of the RTC (76) and the nonvolatile memory (69) in the secondary BIO (77) is always the same as information of the RTC (56) and the nonvolatile memory (49) in the primary BIO (57).

Thus, since the system control unit of this embodiment can back up time information, startup information, and the like in the primary BIO (57) to the secondary BIO (77) at all times, even if a failure or the like occurs in the first IO node (4) having the primary BIO (57) and the first IO node (4) having the primary BIO (57) is separated, the system can be normally started up using information in the secondary BIO (77).

The system control unit has the address conversion part (78) in an IO node controller (60), and on receiving access to an I/O address space allocated to the IO node controller (60), in the address conversion part (78), converts the I/O address space of the received access into an I/O address space indicating an address space specific to the BIO controller (64) and issues access to the converted I/O address space to the BIO (77). By doing so, since the BIO controller (64) can receive the access to the I/O address space, existing BIO controllers used frequently in general PCs or the like can be used without modification to normally start up the system. Hereinafter, with reference to the accompanying drawings, the system control unit in this embodiment will be described.

### (System Configuration of a Large-Scale Computer System)

With reference to FIG. 1, the system configuration of a large-scale computer system in this embodiment will be described. FIG. 1 is a drawing showing the system configuration of a large-scale computer system that connects plural CPU nodes (1, 2) and plural IO nodes (4, 5) by a crossbar network (3).

The large-scale computer system in this embodiment, as shown in FIG. 1, comprises plural CPU nodes (1, 2) and plural IO nodes (4, 5) that are connected to each other over a crossbar network (3).

The first CPU node (1) includes plural CPUs (10 and 11), a CPU bus (12), a CPU node controller (13), and a main memory (14).

Like the first CPU node (1), the second CPU node (2) includes plural CPUs (20 and 21), a CPU bus (22), a CPU node controller (23), and a main memory (24).

The first IO node (4) includes an IO node controller (40), a BIO controller (44), an LPC (Low Pin Count) I/F (46), a nonvolatile memory (49), a Super I/O (50), a PCI (Peripheral Component Interconnect)-X controller (45), PCI-X Bus (47 and 48), and PCI-X devices (51 and 52).

Like the first IO node (4), the second IO node (5) includes an IO node controller (60), a BIO controller (64), an LPC I/F (66), a nonvolatile memory (69), a Super I/O (70), a PCI-X controller (65), PCI-X Bus (67 and 68), and PCI-X devices (71 and 72).

The BIO controller (44, 64) includes LPC interface control parts (55, 75) that control LPC interfaces (46, 66), and RTC (56, 76) having date and time information.

The nonvolatile memories (49, 69) hold information (startup information) and the like needed during startup of the system/OS.

The Super I/Os (50, 70) are LSIs that control a keyboard and a mouse, and an RS232C serial interface such as LPC47S422 manufactured by SMSC Co. (see http://www.smsc.com/main/catalog/lpc47s422.html).

In the IO nodes (4, 5) of this embodiment, a configuration consisting of a combination of the BIO controllers (44, 64), the LPC interfaces (46, 66), the nonvolatile memories (49, 69), and the Super I/Os (50, 70) will be referred to as BIO (Basic Input/Output).

In the large-scale computer system of this embodiment, the BIO (57) in the first I/O node (4), which is preferentially used by the BIOS, will be referred to as a primary BIO. The BIO (77) in the second I/O node (5), which is used as a preparatory of the primary BIO (57), will be referred to as a secondary BIO.

The IO node controllers (40, 60) include address conversion parts (58, 78), which, on receiving an I/O transaction to an address space specified from the BIOS, change the address of the received I/O transaction to indicate the specific address space, and issue the I/O transaction of the changed specific address space to the BIOs (57, 77).

(Control Operation in the Large-Scale Computer System)

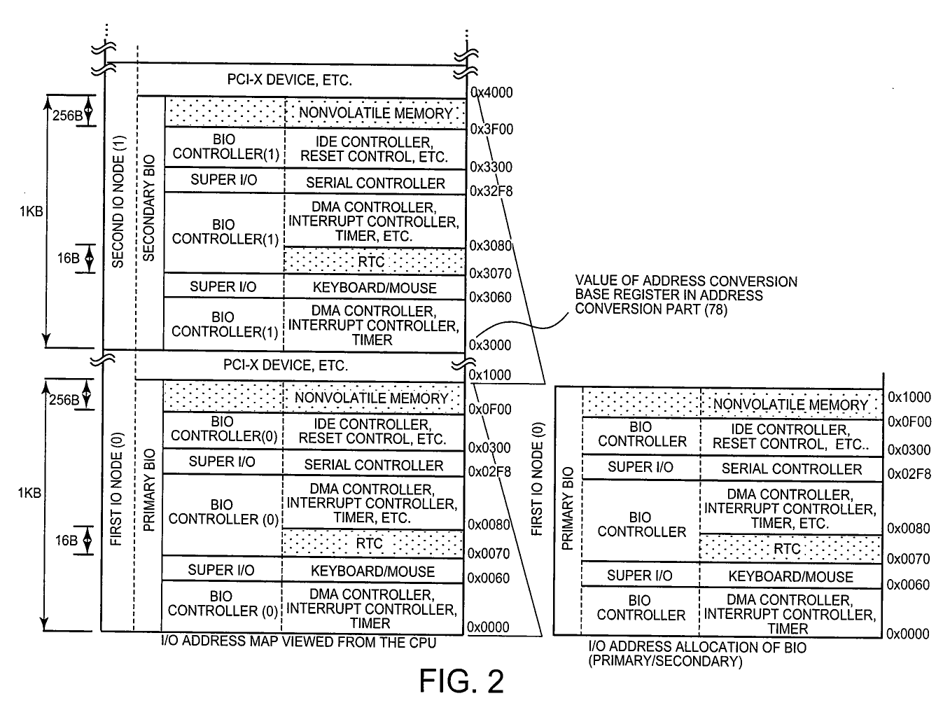

With reference to FIG. 2, control operation in the large-scale computer system of this embodiment will be described. FIG. 2 shows an I/O address map in this embodiment; (a) shows an I/O address map viewed from the CPU node side, and (b) shows I/O address allocation of the BIOs.

An I/O address space specific to the BIOs (57, 77) is shown in the I/O address allocation of the BIOs of (b) of FIG. 2.

A 4-byte area from address 0x0000 to 0x0FFF is an I/O address space of the whole of the BIO controllers (44, 64); a 16-byte area from addresses 0x0070 to 0x007F of it is an I/O address space of the RTCs (56, 66), and a 256-byte area from addresses 0x0F00 to 0x0FFF Is an I/O address space of the nonvolatile memories (49, 69).

The I/O address map viewed from the CPU node side of (a) of FIG. 2 shows an I/O address space of the whole of the system.

The BIOS, during system startup, allocates an I/O address space to each IO node, recognizes the size of the I/O address space required by the each IO node, and based on the recognized size of the I/O address space of the each IO node, allocates a required capacity to the each IO node. At this time, the BIOS allocates the I/O address space to the first IO node (5) four Kbytes more.

The IO node controller (60) in the second IO node (5) allocates a 1-Kyte area (4-Kbyte area from addresses 0x3000 to 0x3FFF in this embodiment) of the I/O address space allocated from the BIOS to the address conversion part (78) as an I/O address space for a preparatory BIO “secondary BIO (77),” and sets the least significant address (address: 0x3000) of the I/O address space (addresses: 0x3000-0x3FFF) in the address conversion base register in the address conversion part (76).

By doing so, on receiving an I/O transaction in the I/O address space of addresses 0x3000 to 0x3FFF, the address conversion part (78) subtract the address 0x3000 set in the address conversion base register from the address of the received I/O transaction to change the I/O transaction to an I/O transaction indicating a specific address space, and issues the changed I/O transaction to the secondary BIO (77).

For example, on receiving an I/O transaction to an address 0x3000, the address conversion part (78) subtract the address 0x3000 set in the address conversion base register from the address 0x3000 of the received I/O transaction that received to change the I/O transaction to an I/O transaction to an address 0x0000, and issues the changed I/O transaction to the secondary BIO (77).

On receiving an I/O transaction to an address 0x3070, the address conversion part (78) subtracts the address 0x3000 set in the address conversion base register from the address 0x3070 of the received input/output transaction, and issues the changed I/O transaction to the secondary BIO (77).

Specifically, when access to an I/O address space allocated to the secondary BIO (77) comes to the secondary BIO (77), since the access has been changed to access to an I/O address space specific to the BIO controller (64), the BIO controller (64) can accept the access to the I/O address space.

In the middle of system startup, the BIOS can copy the value of the RTC (56) of the primary BIO (57) being an original BIO into the RTC (76) of the secondary BIO (77) being a preparatory BIO.

Specifically, the BIOS reads the value of the RTC (56) in the primary BIO (57) by accessing the I/O address space of addresses 0x0070 to 0x007F, and can write the read value to the RTC (76) in the secondary BIO (77) by accessing the I/O address space of addresses 0x3070 to 0x307F.

The BIOS can copy the value of the nonvolatile memory (49) of the primary BIO (57) into the nonvolatile memory (69) in the secondary BIO (77).

Specifically, the BIOS reads the value of the nonvolatile memory (49) in the primary BIO (57) by accessing an I/O address space of addresses 0x0F00 to 0x0FFF, and can write the read value to the nonvolatile memory (69) in the secondary BIO (77) by accessing an I/O address space of addresses 0x3F00 to 0x3FFF. After that, the same startup processing as at normal time is performed and the system is brought into operation.

During system operation, sometimes, the values of the RTC and the nonvolatile memory in the BIO may be changed. For example, this is true when a user changes time, and when the user wants to change a boot path. At this time, the BIOS that actually accesses the RTC and the nonvolatile memory changes the values of the RTC (56) and the nonvolatile memory (49) in the primary BIO (57) by accessing I/O address spaces of addresses 0x0070 to 0x007F and addresses 0x0F00 to 0x0FFF, and at the same time can change the values of the RTC (76) and the nonvolatile memory (69) in the secondary BIO (77) to the same values by accessing I/O address spaces of addresses 0x3070 to 0x307F and addresses 0x3F00 to 0x3FFF.

According to the requirements of DIG64 and the like, the OS and applications are prohibited directly accessing the RTCs and the nonvolatile memories, and the OS and the applications do not need to be changed.

By doing so, information of the RTC (5) and the nonvolatile memory (49) of the primary BIO (57) being an original BIO in the system can always match information of the RTC (76) and the nonvolatile memory (69) of the secondary BIO (77) being a preparatory BIO. As a result, even when the first I/O node (4) of the primary BIO (57) being an original BIO is separated due to a failure of the like, the system can be immediately started up using the secondary BIO (77) being a preparatory BIO.

The above-described embodiment is a preferred embodiment of the present invention and does not limit the scope of the present invention. The present invention may be modified in various ways without departing from the purport of the present invention.

For example, in the above-described embodiment, on receiving an I/O transaction to an address space specified in the IO node controller (60), the second IO node (5) converts the address of the received I/O transaction to indicate the specific address space in the address conversion part (78), and issues the address of the converted I/O transaction to the secondary BIO (77) to change date and time information of the RTC (76) and information of the nonvolatile memory (69) in the secondary BIO (77). However, also in the first IO node (4), like the second IO node (5), on receiving an I/O transaction to an address space specified in the IO node controller (40), the first IO node (4) may convert the address of the received I/O transaction to indicate the specific address space in the address conversion part (58), and issues the address of the converted I/O transaction to the primary BIO (57) to change date and time information of the RTC (56) and information of the nonvolatile memory (49) in the primary BIO (57).

Moreover, although, in the large-scale computer system shown in FIG. 1, the CPU nodes (1, 2) and the IO nodes (4, 5) are connected over the crossbar network (3), a connection between the CPU nodes (1, 2) and the IO nodes (4, 5) is not specially limited, and if information can be exchanged between the CPU nodes (1, 2) and the IO nodes (4, 5), any network may be used. For example, they may be connected using other networks such as a complete network, and plural networks.

The above-described control operation in the IO nodes (4, 5) in this embodiment may be executed by software such as computer programs instead of hardware, and the above-described programs may be recorded in a recording medium such as an optical recording medium, a magnetic recording medium, a magnet-optical memory medium, or semiconductor to execute the above-described control operation in the IO nodes (4, 5) by reading the above-described programs into the IO nodes (4, 5) from the recording medium. The above-described programs may be read into the IO nodes (4, 5) from an external equipment connected over a predetermined network to execute the above-described control operation in the IO nodes (4, 5).

What is claimed is:

1. A system control unit comprising:
a first IO (Input/Output) node having a primary BIO (Basic Input/Output) preferentially used, a first address space being allocated to said first IO node;
a second IO node having a secondary BIO used as a preparatory of the primary BIO, a second address space being allocated to said second IO node are different from each other; and
an information changing means that accesses said first IO node in said first address space to change information in said primary BIO, and accesses said second IO node in said second address space to change information in said secondary BIO, thus bringing the information in said primary BIO and the information in the said secondary BIO into agreement.

2. The system control unit according to claim 1,
wherein said secondary BIO has a specific address space, and
wherein said second IO node comprises an address conversion means that, on receiving an I/O transaction to said second address space, converts the address of the received I/O transaction to indicate said specific address space, and issues the address of the converted I/O transaction to said secondary BIO to change information in said secondary BIO.

3. The system control unit according to claim 1,
wherein said primary BIO has a specific address space, and
wherein said first IO node comprises an address conversion means that, on receiving an I/O transaction to said first address space, converts the address of the received I/O transaction to indicate said specific address space, and issues the address of the converted I/O transaction to said primary BIO to change information in said primary BIO.

4. The system control unit according to claim 1,
wherein said information changing means is executed at least one of during system startup, and during a change request from the OS.

5. The system control unit according to claim 1,
wherein the primary BIO and the secondary BIO comprise:
a date and time information holding means that holds date and time information; and
a startup information holding means that holds startup information required during startup of the system,
wherein said information changing means brings date and time information and startup information in said primary BIO, and date and time information and startup information in said secondary BIO into agreement.

6. A system control method performed in a system control unit comprising a first IO (Input/Output) node having a primary BIO (Basic Input/Output) preferentially used, and a second IO node having a secondary BIO used as a preparatory of said primary BIO, said system control method comprising:
allocating a first address space to said first IO node;
allocating a second address space to said second IO node are different from each other;
accessing said first IO node in said first address space;
changing information in said primary BIO;
accessing said second IO node in said second address space; and
changing information in said secondary BIO to bring the information in said primary BIO and the information in said secondary BIO into agreement.

7. The system control method according to claim 6, further comprising:
when said secondary BIO receives said I/O transaction to said second address space, converting the address of a received I/O transaction to indicate a specific address space which said secondary BIO has; and
issuing the address of the converted I/O transaction to said secondary BIO for changing information in said secondary BIO.

8. The system control method according to claim 6, further comprising:
when said first IO node receives an I/O transaction to said first address space, converting the address of the received I/O transaction to indicate said specific address space which said primary BIO has; and
issuing the address of the converted I/O transaction to said primary BIO for changing information in said primary BIO.

9. The system control method according to claim 6,
wherein changing information in said primary and secondary BIO is executed at least one of during system startup, and during a change request from the OS.

10. The system control method according to claim 6,
wherein said changing information in said primary and secondary BIO brings date and time information and startup information held in said primary BIO, and date and time information and startup information held in said secondary BIO into agreement.

11. A computer readable medium storing a system control program executed in a system control unit comprising a first IO (Input/Output) node having a primary BIO (Basic Input/Output) preferentially used, and a second IO node having a secondary BIO used as a preparatory of said primary BIO,
wherein a first address space allocated to said first IO node, and a second address space allocated to said second IO node are different from each other,
wherein the system control program instructs the system control unit to perform an information changing processing that accesses said first IO node in said first address space to change information in said primary BIO, and accesses said second IO node in said second address space to change information in said secondary BIO, and
wherein the information in said primary BIO and the information in said secondary BIO are brought into agreement.

12. The computer readable medium storing the system control program according to claim 11,
wherein said secondary BIO has a specific address space, and
wherein said second IO node, on receiving an I/O transaction to said second address space, converts the address of the received I/O transaction to indicate said specific address space, and issues the address of the converted I/O transaction to said secondary BIO to change information in said secondary BIO.

13. The computer readable medium storing the system control program according to claim 11,
wherein said primary BIO has a specific address space, and
wherein said first IO node, on receiving an I/O transaction to said first address space, converts the address of the received I/O transaction to indicate said specific address space, and issues the address of the converted I/O transaction to said primary BIO to change information in said primary BIO.

14. The computer readable medium storing the system control program according to claim 11,
wherein said information changing processing is performed at least one of during system startup, and during a change request from the OS.

15. The computer readable medium storing the system control program according to claim 11,
wherein said primary BIO and said secondary BIO comprise:
a date and time information holding means that holds date and time information; and
a startup information holding means that holds startup information required during startup of the system, and
wherein said information changing processing brings date and time information and startup information in said primary BIO, and date and time information and startup information in said secondary BIO into agreement.
